(19) United States
(12) Patent Application Publication
(10) Pub. No.: US 2011/0032729 A1
(43) Pub. Date: Feb. 10, 2011

(54) ORTHOGONALLY SEPARABLE LIGHT BAR

(75) Inventors: Dung T. Duong, Cedar Park, TX (US); Hyunchul Ko, Austin, TX (US)

Correspondence Address: SPRINKLE IP LAW GROUP, 1301 W. 25TH STREET, SUITE 408, AUSTIN, TX, 78705, US

(73) Assignee: ILLUMITEX, INC., AUSTIN, TX (US)

(21) Appl. No.: 12/846,465

(22) Filed: Jul. 29, 2010

Related U.S. Application Data
(60) Provisional application No. 61/229,642, filed on Jul. 29, 2009.

(51) Int. Cl. F21V 7/22

(52) U.S. Cl. 362/607; 362/611; 362/612

(57) ABSTRACT

Embodiments described herein provide optical systems in which phosphors are used to down-convert light. In general, optical systems can include a light guide configured to propagate light from an entrance face to a distal end along a propagation axis using total internal reflection. A phosphor layer can be disposed orthogonal to the entrance surface of the light guide.

### RELATED APPLICATION

This application claims the benefit of priority under 35 USC §119(e) to U.S. Provisional Patent Application Ser. No. 61/229,642 by inventors Dung T. Duong and Hyunchul Ko, entitled “Orthogonally Separable Light Bar”, filed Jul. 29, 2009, the entire contents of which are hereby expressly incorporated by reference for all purposes.

### TECHNICAL FIELD

Embodiments described herein relate to optical systems. More particularly, embodiments described herein relate to optical systems using phosphors to down convert light.

### BACKGROUND

LEDs are used to generate light for a variety of applications. In some cases, phosphors are used in conjunction with the LEDs to produce a desired color of light. In traditional systems of using phosphors with LEDs, phosphors are coated on a dome that surrounds the LED. These systems, however, suffer from heat related inefficiencies.

An LED inherently heats when transforming electrical energy to light. The addition of phosphors to an LED package causes additional heating through absorption of light by the LED and transference of heat from phosphors to the LED. Heat causes the LED efficiency and phosphor quantum efficiencies to drop, thereby reducing the overall LED package efficiency.

To address the issue of absorption, the LED must be highly reflective of the down-converted light generated by the phosphors, adding complication to the LED device. To address heat transfer from the phosphors to the LED, the phosphors can be disposed in a layer removed from the LED chip. In such an arrangement, the LED is typically surrounded by a cup with the LED at the bottom of the cup on a phosphor layer disposed at the other end. The LED provides light to the phosphor layer which down converts the light. Some portion of the down-converted is emitted out of the cup (i.e., away from the LED), while another portion is emitted back into the cup (i.e., toward the LED). In such an arrangement, the LED still absorbs a large amount of back-scattered light. Moreover, it is difficult to cool the phosphors without placing a cooling mechanism between the phosphor layer and the intended target for the light.

Additional problems arise when using multiple colors of phosphors to attain a specific color point or to match the color filters of LCD panels. Namely, phosphors can self-absorb. For instance a red-emitting phosphor may absorb down-converted light from a green-emitting phosphor instead of the pump wavelength. Such absorption introduces losses into the system making it difficult to minimize absorption and maximize package efficiency in the system. Additionally, when multiple phosphors are used in proximity to each other, it is difficult to achieve pump light uniformity to the phosphors.

### SUMMARY OF THE DISCLOSURE

Embodiments described herein provide optical systems in which phosphors are used to down-convert light. In general, optical systems can include a light guide configured to propagate light from an entrance face to a distal end along a propagation axis using total internal reflection. A phosphor layer can be disposed orthogonal to the entrance surface of the light guide.

The orthogonal arrangement can help reduce heating of the LED and phosphors. Depending on the length scales, the pump source only occupies a small angular subtense as viewed by the phosphor. Consequently, the amount of light backscattered by the phosphors that will reach the light source may be relatively small, thereby reducing absorptive heating at the light source. Furthermore, while the pump source may have a relatively high exitance, the phosphor may have a relatively low irradiance. This implies that per unit area, the flux density of pump energy on the phosphor is relatively small, thus leading to low thermal rise due to Stoke Shifts. To further reduce heating, the phosphors can be independently cooled without placing the cooling mechanisms between the phosphors and the intended target.

The phosphor layer can comprise multiple colors of phosphors with areas of each color spatially separated from other colors by a gap. It is believed that such an arrangement can reduce re-absorption in the phosphor layer, thereby increasing overall package efficiency. Color blending from the various colors of phosphors can occur in the light guide or external to the light guide. For example, according to one embodiment, the exit surface of the light guide can be a selected distance from the phosphor layer so that color blending primarily occurs in the light guide and the light guide emits a substantially uniform color from the exit surface. In another embodiment, the light guide can be configured so that color blending primarily occurs external to the light guide.

The optical system can include a reflector to reflect light emitted by phosphors or escaping from sidewalls of the light guide. The use of reflector can increase overall efficiency of the optical system to redirect down-converted light that might otherwise be lost.

Embodiments of optical systems described herein provide advantages over traditional systems of using phosphors in conjunction with light sources by reducing heating at the light source due to absorption of down-converted light.

Embodiments described herein provide another advantage by potentially leading to lower thermal rise due to Stoke's shift.

Embodiments described herein provide yet another advantage because a light source's temperature no longer has a significant influence on the phosphor temperature and vice versa.

Embodiments described herein provide yet another advantage by allowing for independent cooling of phosphors over a much larger surface area.

Embodiments described herein provide yet another advantage by reducing phosphor self-absorption.

Embodiments described herein provide another advantage by allowing the use of nano phosphor particles or quantum dots. Because the nanoparticles/quantum dots can be positioned away from the source and can be independently cooled, the temperature of the nanoparticles/quantum dots can be controlled to prevent heat degradation of the binder material used with the nanoparticles/quantum dots.

### BRIEF DESCRIPTION OF THE DRAWINGS

A more complete understanding of the embodiments and the advantages thereof may be acquired by referring to the following description, taken in conjunction with the accompanying drawings in which like reference numbers indicate like features and wherein:

FIG. 1 is a diagrammatic representation of an embodiment of an optical system;

FIG. 2 is a diagrammatic representation of an embodiment of an optical system down-converting light;

FIG. 3 is a diagrammatic representation an embodiment of an optical system illustrating light internally reflecting at the sidewalls of a light guide;

FIG. 4 is a diagrammatic representation of an embodiment of an optical system with a reflector;

FIG. 5 is a diagrammatic representation of an embodiment of an optical system with spatially separated phosphors;

FIG. 6 is a diagrammatic representation of an embodiment of an optical system with phosphor layers on multiple sides;

FIG. 7 is a diagrammatic representation of an embodiment of an optical system with a light source a distance from the light guide;

FIG. 8 is a diagrammatic representation of an embodiment of an optical system with multiple light sources;

FIG. 9 is a diagrammatic representation of an another embodiment of an optical system with multiple light sources;

FIG. 10 is a diagrammatic representation of yet an another embodiment of an optical system with multiple light sources;

FIG. 11 is a diagrammatic representation of an embodiment of an optical system having a light guide with shaped sidewalls;

FIG. 12 is a diagrammatic representation of another embodiment of an optical system having a light guide with shaped sidewalls;

FIG. 13 is a diagrammatic representation of another embodiment of an optical system having a light guide with an arbitrary shape;

FIG. 14 is a diagrammatic representation of another embodiment of an optical system; and

FIG. 15 is a diagrammatic representation of a light bulb using one embodiment of an optical system.

### DETAILED DESCRIPTION

The disclosure and various features and advantageous details thereof are explained more fully with reference to the exemplary, and therefore non-limiting, embodiments illustrated in the accompanying drawings and detailed in the following description. Descriptions of known starting materials and processes may be omitted so as not to unnecessarily obscure the disclosure in detail. It should be understood, however, that the detailed description and the specific examples, while indicating the preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited to only those elements but may include other elements not expressly listed or inherent to such process, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead these examples or illustrations are to be regarded as being described with respect to one particular embodiment and as illustrative only. Those of ordinary skill in the art will appreciate that any term or terms with which these examples or illustrations are utilized encompass other embodiments as well as implementations and adaptations thereof which may or may not be given therewith or elsewhere in the specification and all such embodiments are intended to be included within the scope of that term or terms. Language designating such non-limiting examples and illustrations includes, but is not limited to: “for example,” “for instance,” “e.g.,” “in one embodiment,” and the like.

Embodiments described herein provide optical systems in which phosphors are used to down-convert light. The phosphors are disposed on a light guide orthogonal to an entrance surface to the light guide. This orthogonal separation can reduce the amount of light from the phosphors that re-enters the pump source and prevent heat from the phosphors from heating the pump source.

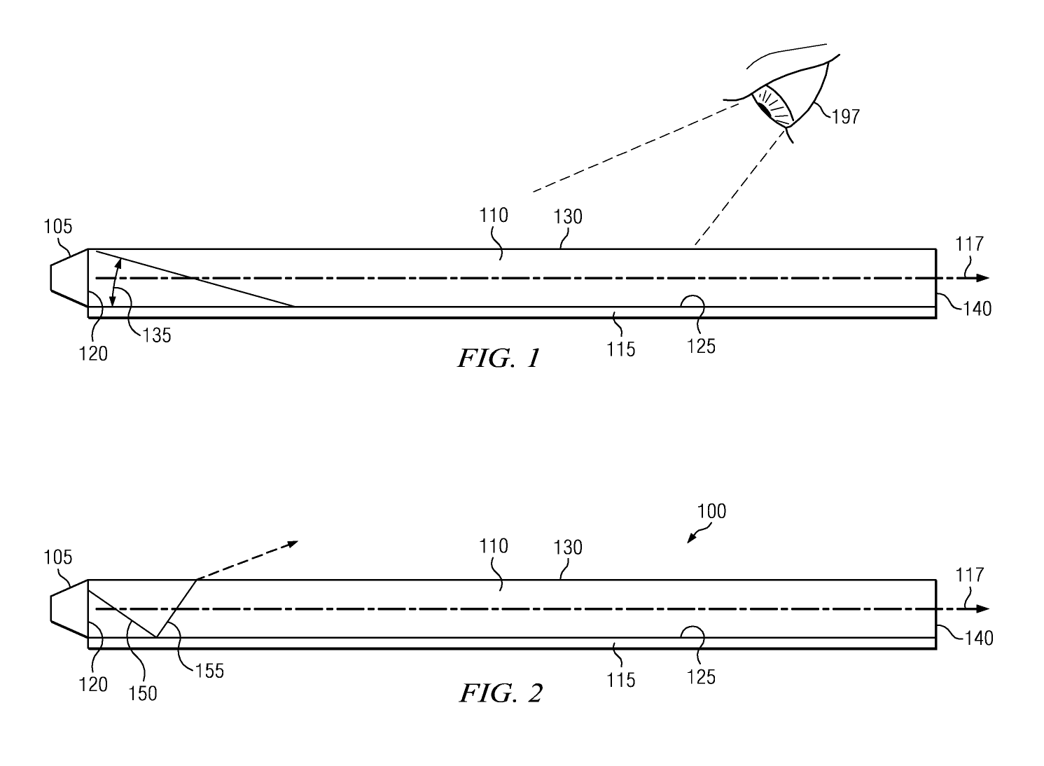

FIGS. 1 and 2 are diagrammatic representations of one embodiment of an optical system comprising a light source 105, a light guide 110 and a phosphor layer 115. Light source 105 can be any suitable light source including an LED, array of LEDs or other light source emitting light in a desired color or colors, including but not limited to red, green, blue, yellow, ultraviolet or other light color. Light source 105 can include packaging and additional optics. According to one embodiment, light source 105 can utilize shaped separate optical devices as described in U.S. patent application Ser. No. 11/649,018, entitled “SEPARATE OPTICAL DEVICE FOR DIRECTING LIGHT FROM AN LED,” filed Jan. 3, 2007 which is hereby fully incorporated by reference herein, shaped substrate LEDs as described in U.S. patent application Ser. No. 11/906,194, entitled “LED SYSTEM AND METHOD,” filed Oct. 1, 2007, which is hereby fully incorporated by reference herein, and LEDs with shaped emitter layers as described in U.S. patent application Ser. No. 12/367,343, entitled “SYSTEM AND METHOD FOR EMITTER LAYER SHAPING,” filed Feb. 6, 2009, which is hereby fully incorporated by reference herein.

Light guide 110 is an optical wave guide that propagates light from entrance face 120 to a distal end 140 along a primary propagation axis 117. Light guide 110 is formed of a material to promote total internal reflection of light from light source 105. Example materials include, but are not limited to, glass, extruded plastic, polyacrylate, polycarbonate or other material. Light guide 110 can be square, rectangular, tubular or otherwise shaped.

Phosphor layer 115 is disposed on one or more surfaces that are orthogonal to entrance surface 120. The phosphors can be applied according to any technique known or developed in the art. By way of example, but not limitation, phosphor layer 115 can include phosphor particles mixed with an adhesive, such a silicone. The particles in phosphor layer 115 can include quantum dots, phosphor nano-particles or other sizes of phosphor particles. The size, concentration, density, thickness, pattern, emission wavelength or other property of the particles can vary along the length of the light guide to control the uniformity or color and to direct the appropriate amount of energy out of the system. Phosphor layer 115 can be disposed along the entire length of light guide 110, a substantial portion of light guide 110 or along any desired portion of light guide 110.

Phosphor layer 115 can include various colors of phosphors. Light guide 110 can be configured so that color blending occurs in light guide 110. For example, according to one embodiment, surface 125 and exit surface 130 can be a selected distance “h” apart such that color from the various phosphors is primarily blended in light guide 110. Consequently, light guide 110 will emit light of a desired color from surface 130, though there may be some edge effects. In another embodiment, light guide 110 may emit light that has noticeably different colors in near field, but that become blended external to light guide 110 to become a desired color at far field (e.g., as seen by human, electronic observer or other target 197).

In general, the further away a particular phosphor particle is from entrance face 120, the less likely light emitted by that particle will reenter the pump source. In the example of FIG. 1, only the portion of phosphor under the line at angle 135 will emit light that can directly reenter the pump source (though some additional light may be reflected to the pump source). Compared to traditional systems, the potential for backscattered light to reenter the pump source is reduced.

While particles further away from entrance face 120 are less likely to emit light that will be absorbed by light source 105, such particles are also less likely to receive light from light source 105 in the first place. If phosphor layer 115 is uniform over a relatively long light guide 110, the area of light guide 110 closer to light source 105 may emit noticeably brighter light. To account for this, the phosphor particle density distribution can increase along the length of light guide 110 to produce a more uniform emission pattern from light guide 110.

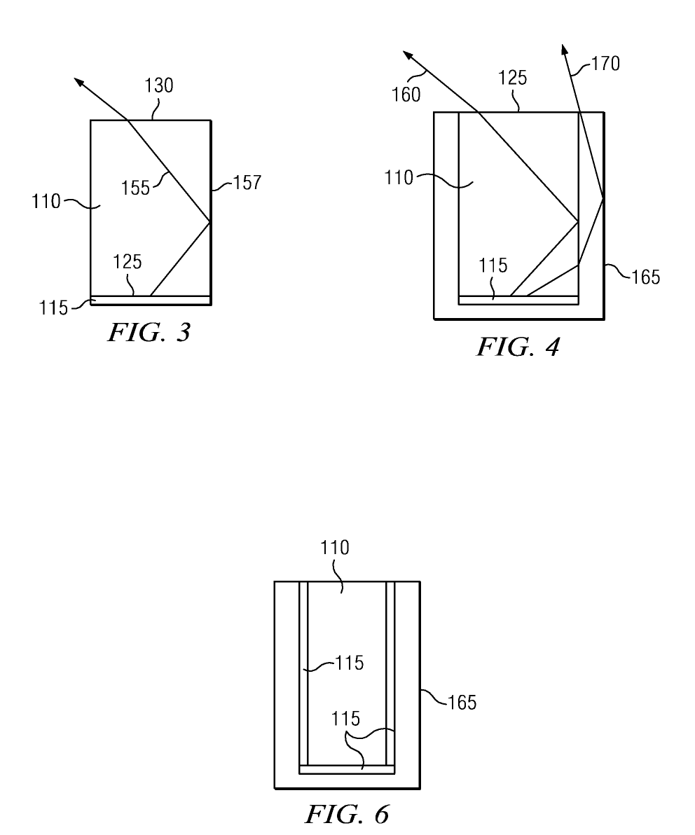

As light propagates along light guide 110, some light that will be incident on surface 125 and will be down converted by phosphors in phosphor layer 115. The phosphor will emit some portion of the down-converted light back into light guide 110. The down-converted light can exit light guide 110 through exit surface 130. FIG. 2 illustrates and example of a light ray propagated by light guide 110 along propagation axis 117. For the purposes of FIG. 2, it is assumed that light source 105 is a blue light pump and that phosphor layer 115 contains yellow phosphor particles. Blue light 150 enters light guide 110 through entrance face 120, is internally reflected at surface 130 and is incident on surface 125. The phosphor particles in phosphor layer 115 down-converts blue light 150 to yellow light 155 and preferentially emits yellow light 155 normal to the angle of incidence of blue light 150. If yellow light 155 is incident on surface 130 at less than or equal to the critical angle, yellow light 155 will exit light guide 110 through surface 130. If yellow light 155 is incident on surface 130 at greater than the critical angle, yellow light 155 may propagate in light guide 110 until it exits or is absorbed. FIG. 3 illustrates that light (e.g., yellow light 155) may also internally reflect at sidewalls 157.

In general, light down-converted by the phosphors will exit light guide 110 from exit surface 130. However, because phosphors are lambertian emitters, the phosphors will emit some portion of light away from light guide 110. Additionally, even if the down-converted light is emitted into the light guide 110, some portion of the light may exit sidewalls 157. According to one embodiment, a reflector can be used to direct light in a desired direction. FIG. 4 is a diagrammatic representation of an embodiment of an optical system that includes an external reflector 165 disposed about light guide 110. The reflector 165 can reflect light emitted by phosphors 115 away from light guide 115 or light escaping light guide 110 through the sidewalls and distal end 140. By way of example, but not limitation, the reflector can be a diffuse or specular reflector and can be formed of Teflon, Teflon paper, diffuse reflective plastic, silver coated plastic, white paper, TiO₂ coated material or other reflective material.

While reflector 165 is shown on the three sides of the light guide, the reflector may be on one or two sides of the light guide. In other embodiments, the reflector may also be disposed to reflect light from the end of the light guide opposite of the pump source. If the light guide is shaped for angular control, an orthogonally separable diffuser can be used to divert light toward the phosphor.

According to one embodiment, reflector 165 touches, but is not in intimate contact with light guide 110. In other words, reflector 165 can be lightly set without an optical interface leaving inherently small air gaps. In this case, the reflector 165 may contact the light guide 110 in limited places, but gaps still exist between a majority of reflector 165 and light guide 165. In other embodiments, reflector 165 does not make contact with light guide 110. A gap, which is potentially very thin, can be maintained between reflector 165 and the light guide 110 to preserve total internal reflection. While gaps between light guide 110 and reflector 165 may simply filled with the surrounding medium (e.g., air), they may also be filled with a material having an index of refraction that preserves total internal reflection in light guide 110. In other embodiments, reflector 165 may be in intimate contact with light guide 110. That is, reflector 165 may be pressed against light guide 110 or coupled to light guide 110 with a liquid, adhesive, compliant material or other material.

According to one embodiment, the optical system can be configured so that scattered pump light or down-converted light will strike the reflector. Pump light that remains inside light guide 110 may not make it out the light guide on the first pass, but upon subsequent passes and scattering, the optical system will allow the majority of the energy to escape.

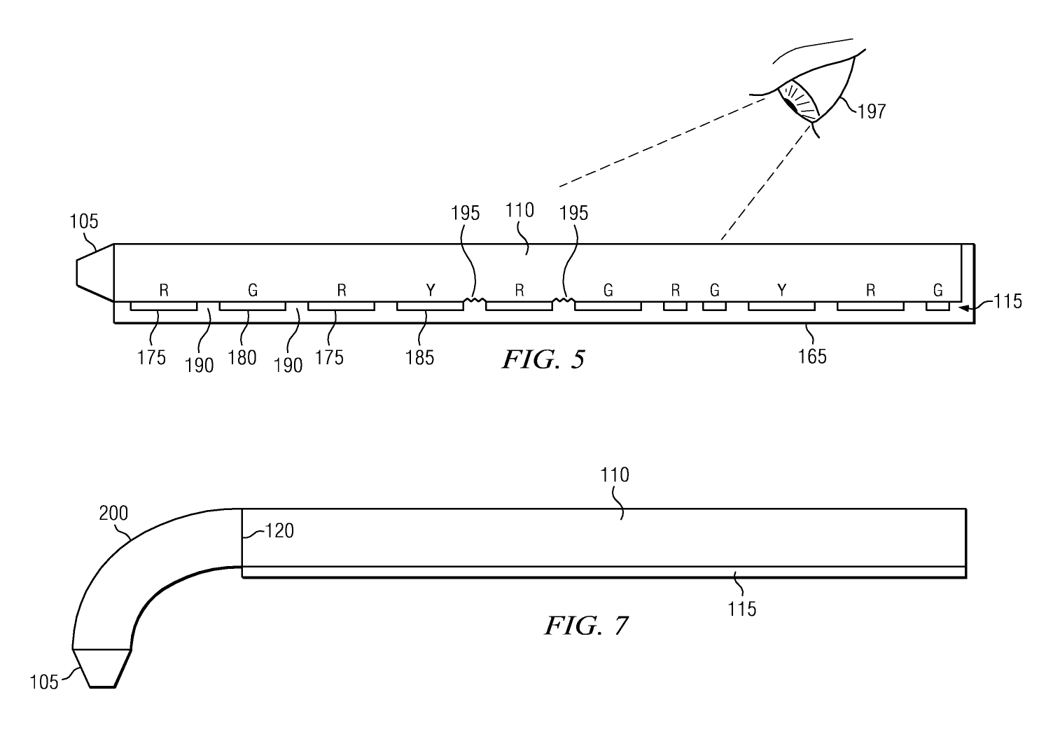

FIG. 5 is a diagrammatic representation of another embodiment of an optical system having light source 105, light guide 110 and phosphor layer 115 in which phosphors of various colors are spatially separated from each other. Using the example of red, green and yellow phosphors, phosphor layer 115 can include patches of red phosphors 175, green phosphors 180 and yellow phosphors 185 spatially separated by gaps 190. Each patch may include phosphors of a single color or may simply include a higher concentration of phosphors of the desired color while still containing phosphors of other colors. The patches can be configured so that the density or other aspect of the phosphor particles varies along the length of light guide 110 to produce a desired light output. It is believed that spatially separating phosphors of different colors can reduce re-absorption in the phosphor layer, thereby increasing overall package efficiency.

To minimize light loss through gaps 190, gaps 190 can include features 195 to scatter light, such as surface roughening, micro-facets or other features that cause light incident on features 195 to scatter. In other embodiments, the optical system can include reflectors (e.g., reflector 165) to reflect light that may otherwise escape gaps 190.

In the embodiments of FIGS. 1-5, phosphor layer 115 is disposed on a single side of light guide 110. In other embodiments, phosphor layer 115 may be disposed on other or additional surfaces of light guide 110. FIG. 6, for example, is a diagrammatic representation of another embodiment of an optical system, similar to that of FIG. 4, but with phosphor layer 115 disposed on multiple surfaces orthogonal to entrance face 120.

In some cases, the pump source is not directly in line with the light guide but can be optically coupled to the light guide using fiber optics, reflectors or other optical coupling mechanisms. FIG. 7, for example, illustrates a pump source 115 coupled to the light guide 110 by a fiber optic cable 200. In this example, light enters light guide 110 through entrance face 120. Phosphor layer 115 is disposed orthogonal to entrance face 120, but not necessarily orthogonal to light source 115.

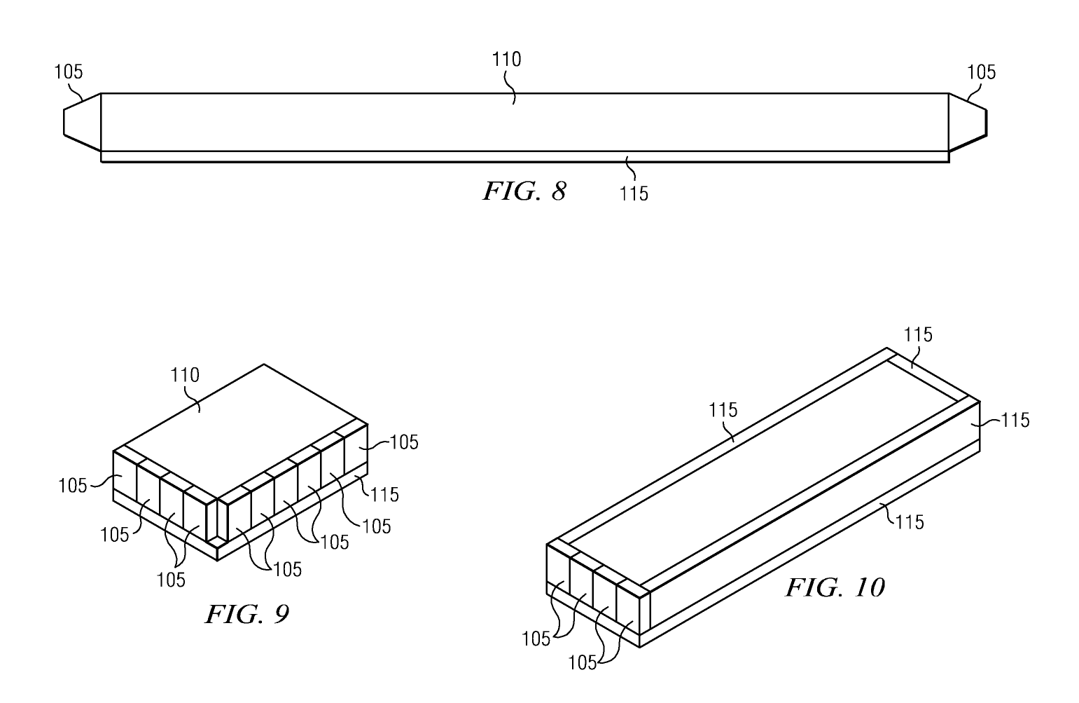

FIGS. 8-9 are diagrammatic representations of embodiments of optical systems in which multiple light sources 105 are arranged about a light guide 110 such that phosphor layer 115 is orthogonal to the light sources 105. The light sources 105 can include light sources producing a single color or multiple colors of light. As shown in the example of FIG. 9, light guide 110 may have multiple entrance faces. FIG. 10 is a diagrammatic representation illustrating another embodiment of an optical system with multiple light sources 105. In the embodiment of FIG. 10, phosphor layer 115 is disposed on multiple surfaces of light guide 110 including surfaces orthogonal to the entrance face.

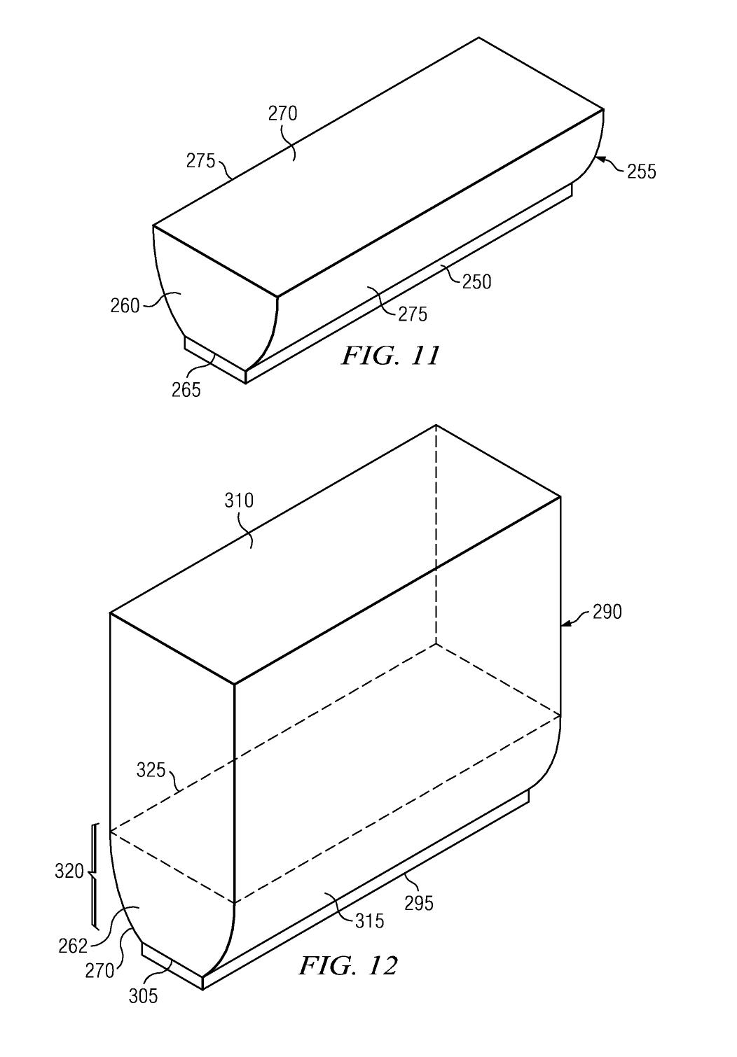

Orthogonally separated phosphors can be used with light guides having a variety of shapes. FIG. 11 is a diagrammatic representation of one embodiment of a phosphor layer 250 used in conjunction with a light guide 255. Light guide 255 includes an entrance face 260 through which light from a light source enters light guide 255, a phosphor coated surface 265, an exit surface 270 and a set of shaped sidewalls 275. The shapes of sidewalls 275 can be selected so that light emitted by phosphor layer 115 and incident on sidewalls 275 is directed to exit surface 270. Sidewalls 275 can be multi-faceted, multi-parabolic or otherwise shaped so that light guide 255 emits light in a selected distribution pattern in a desired half angle. According to one embodiment, the width of exit surface 270 and shape of sidewalls 275 can be selected as if light guide 255 is a radiance conserving device. According to one embodiment, the sidewalls can be shaped as described in U.S. patent application Ser. Nos. 11/649,018, 11/906,194, and 12/367,343, which are hereby fully incorporated by reference herein.

FIG. 12 is another embodiment of a light guide 290 used in conjunction with a phosphor layer 295. Light guide 290 includes an entrance face 300 through which light from a light source enters light guide 290, a phosphor coated surface 305, an exit surface 310 and a set of sidewalls 315. Section 320 of light guide 290 is similar to light guide 255. The sidewalls 315 in section 320 can be shaped so that light passes through plane 325 with a desired angle to create a desired output from surface 310. According to one embodiment, sidewalls 315 can be shaped similarly to sidewalls 275 in shaped section 320. The remainder of sidewalls 315 can be straight or have other desired shape.

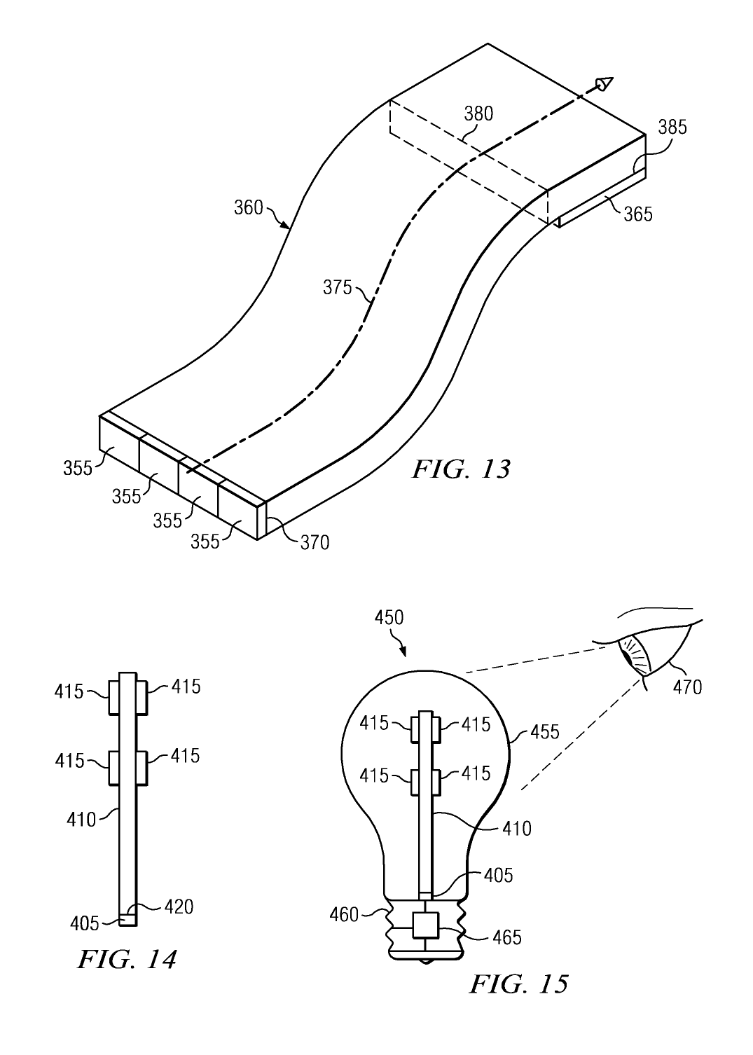

FIG. 13 illustrates another embodiment of an optical system including a set of light sources 355, a light guide 360 and a phosphor layer 365. In the embodiment of FIG. 13, light enters light guide 360 through entrance face 370 and propagates along the primary propagation axis 375. The light passes through an entrance plane 380 to a phosphor the coated section. Entrance plane 380 is normal to the primary propagation axis 375. Phosphor layer 365 is disposed on a surface 385 orthogonal to the entrance plane 380. In this example, surface 385 is not necessarily geometrically orthogonal to entrance surface 370, but is, instead, orthogonal to entrance surface 370 from a light propagation perspective.

FIG. 14 is a diagrammatic representation of an embodiment of an system comprising a light source 405, a light guide 410 and phosphor layer 415 disposed on light guide 410 orthogonal to entrance surface 420. According to one embodiment, various colors of phosphors can be used in phosphor layer 415, including spatially separated phosphors of various colors. The configuration of phosphors can be selected so that light from the various colors of phosphors blend to create a desired color in far field.

FIG. 15 is a diagrammatic representation a light bulb 450 using one embodiment of an optical system. Light bulb 450 includes a glass bulb 455, a socket 460 and circuitry 465 to convert electricity provided by a light socket to the input used by light source 405. Light from light source 405 propagates down light guide 410 to be incident on phosphor layers 415. The color, density pattern and other aspects of phosphor layers 415 can be selected so that light emitted by the phosphors blends to create uniform light to a far field observer 470.

One advantage of light bulb 450 is that the light source 405 can be securely mounted near the socket, rather than near the center of glass bulb 455. Because the light is guided by light guide 410 to the phosphors, light will appear to an observer to be generated at a more traditional location (e.g., near the center of glass bulb 455). Because the phosphors are remote from the light source 405, overheating of the light source 405 is reduced or avoided.

Embodiments described herein provide optical systems in which a phosphor layer is disposed orthogonal to an entrance surface of a light guide. The phosphor layer can be disposed on the light guide by being disposed directly on the surface of the light guide or disposed on the light guide with other layers in between. The phosphor layer can include phosphor particles mixed in silicone or other adhesive, phosphors embedded in a clear plastic or acrylic sheet that is optically coupled the surface of the light guide, phosphors sandwiched between sheets of material or phosphors otherwise disposed so that light from the light guide can be incident on the phosphors. The phosphor layer can include a continuous layer of phosphors or spatially separated sections. The size, concentration, density, thickness, pattern, emission wavelength or other property of the particles can vary along the length of the light guide to control the uniformity or color along the light guide and to direct the appropriate amount of energy out of the system.

According to one embodiment, phosphors can be located remote from an LED pump source. That is, the distance of the phosphors from the LED is at least 2:1 of the LED die width. In other embodiments the phosphors may be located closer to the LED (e.g., to be proximate to the exit surface of the LED) or may be located at much farther distances (e.g., greater 10:1).

Additionally, embodiments described herein can include features to cool the phosphors including heat sinks, heat pipes, convective air cooling, fluid cooling or other cooling mechanisms. According to one embodiment, the optical systems can be arranged so that the temperature of the phosphors will not degrade a binding material.

While this disclosure describes particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the disclosure.

What is claimed is:

1. An optical system comprising:
a light guide having a plurality of surfaces, wherein the light guide is configured to propagate light through total internal reflection from the entrance surface to a distal end of the light guide along a primary propagation axis;
a light source optically coupled to an entrance surface of the light guide; and
a phosphor layer disposed on the light guide orthogonal to the entrance surface.

2. The optical system of claim 1, wherein the light guide further comprises an exit surface opposite from the phosphor layer.

3. The optical system of claim 2, wherein the phosphor layer comprises multiple colors of phosphors.

4. The optical system of claim 3, wherein the multiple colors of phosphors are spatially separated.

5. The optical system of claim 4, wherein the light guide comprises diffusers on the selected surface located at gaps between the spatially separated phosphors.

6. The optical system of claim 3, wherein the phosphor and exit surface are a select distance apart so that color blending of light emitted by the multiple colors of phosphors occurs in the light guide to produce a uniform color of light at the exit surface of the light guide.

7. The optical system of claim 3, wherein color blending of light emitted by the multiple colors of phosphors occurs primarily external to the light guide.

8. The optical system of claim 2, further comprising a reflector positioned on the obverse side of the phosphor layer from the light guide.

9. The optical system of claim 8, wherein the reflector is further positioned to reflect light escaping sidewalls of the light guide.

10. The optical system of claim 1, wherein the phosphor layer is configured such that the optical system produces a uniform color in far field.

11. The optical system of claim 1, wherein the phosphor layer is configured such that the optical system produces a uniform color in near field.

12. The optical system of claim 1, wherein the phosphor layer comprises phosphor particles embedded in an adhesive.

13. The optical system of claim 1, wherein the phosphor layer comprises phosphor nanoparticles.

14. The optical system of claim 1, wherein the light source comprises an LED array.

15. The optical system of claim 1, wherein the light source is optically coupled to the entrance surface of the light guide by a fibre optic cable.

16. A method for an optical system comprising:
providing a light guide having a plurality of surfaces and configured to propagate light through total internal reflection from an entrance surface to a distal end of the light guide along a primary propagation axis;
disposing a phosphor layer on the light guide orthogonal to the entrance surface; and
optically coupling a light source to the entrance surface of the light guide.

17. The method of claim 16, wherein disposing the phosphor layer further comprises disposing a phosphor layer having multiple colors of phosphors.

18. The method of claim 17, wherein the multiple colors of phosphors are disposed so that each color of phosphor is spatially separated from other colors of phosphors.

19. The method of claim 16, further comprising positioning a reflector to reflect light emitted by the phosphor layer on the obverse side from the light guide.

20. The method of claim 16, further comprising disposing the phosphor layer remote from the light source.
